(19) United States
(12) Patent Application Publication
(10) Pub. No.: US 2010/0171722 A1
(43) Pub. Date: Jul. 8, 2010

(54) TOUCH PANEL DEVICE

(75) Inventors: Tzu-jung Chen, Hsin-Chu City (TW); Kuo-chang Su, Hsin-Chu City (TW); Po-yuan Liu, Hsin-Chu City (TW)

Correspondence Address: AUSTIN RAPP & HARDMAN, 170 South Main Street, Suite 735, SALT LAKE CITY, UT, 84101, US

(73) Assignee: AU Optronics Corp., Hsin-Chu (TW)

(21) Appl. No.: 12/544,526

(22) Filed: Aug. 20, 2009

(30) Foreign Application Priority Data
Jan. 6, 2009 (TW) 098101688

(51) Int. Cl. G06F 3/041; G06F 3/045

(52) U.S. Cl. 345/174; 345/173

(57) ABSTRACT

A touch panel includes a transparent conductive layer, a closed-loop electrode member circled around the transparent conductive layer, and a signal-transferring layer separated from the transparent conductive layer. The signal-transferring layer includes a transmission trace and a pad. The respective pads are located at four comers of the display device. Each transmission trace can conduct an electric current when an object contacts the transparent conductive layer. The signal-transferring layers and the electrode members are made of an identical conductivity material.

### BACKGROUND OF THE INVENTION

1. Claim of Priority

This application claims priority to Taiwanese Patent Application No. 098101688 filed on Jan. 16, 2009.

2. Field of the Invention

The present invention relates to a display panel for use in a flat display device, and more particularly, to a touch liquid crystal panel for use in a flat display device.

3. Description of the Related Art

More and more advanced-function displays have found their applications in current consumer electronic products. In particular, liquid crystal displays (LCDs) having a high-resolution color screen are more widely applied in various electronic devices, such as televisions, mobile phones, personal digital assistances (PDA), digital cameras, desktop computer screens, and notebook computer screens.

To facilitate portability and usage of these devices, touch-control LCDs with an LCD touch panel to allow direct touch by the users have become the trend in the LCD market. Conventional optical touch panels are configured by disposing a large amount of light sources and corresponding optical detecting elements around an LCD panel. The coordinate position of a touch-point is determined when determining the position of an optical detecting element has failed to receive light rays from a corresponding light source. Although this design would not decrease the overall light transmittance through the panel, the product size is significantly increased. Conventional resistive type or capacitive type LCD touch panels, which are configured by disposing additional resistors or capacitors on the panels, determine the coordinate positions of touch-points by detecting the voltage variation at the touch positions. However, since the resistors and capacitors are directly disposed on the panels, light transmittance through the LCD panel will be decreased and the overall thickness of the LCD panel will be increased.

Referring to FIG. 1 showing a structure diagram of a conventional capacitive touch panel 10, and FIG. 2 illustrating a distribution diagram of an electrode layer 16 of the conventional capacitive touch panel 10, the capacitive touch panel 10 comprises a transparent glass 12 plated with an indium tin oxide (ITO) film 18 and a hard coat layer 14. Several shielded layers are needed to be disposed between the capacitive touch panel 10 and a LCD monitor for suppressing electromagnetic disturbance (EMI). When users do not make contact with the touch panel, an electrode layer 16 is at the same electric potential, and no electric currents pass through the touch panel 10. Once users make contact with the touch panel 10, static electricity flowing through the users' body to the ground causes small electric currents can be detected. According to a change of the detected small electric current, contact points on the touch panel can be pinpointed. The ITO layer 18 on the surface of the glass 12 has resistivity. In order to maintain the same electric field, the surrounds of the ITO layer 18 are stalled with an electrode layer 16, which electric currents can flow in from four sides or corners. In order to adapt linearity of the distribution of electric fields of the touch panel 10, the electrode layer 16 surrounded the touch panel 10 is made of metal, as shown in FIG. 2. The design of the surrounding electric field 16 comprising a plurality of discrete conductivity segments 101 is utilized to improve linearity of electric fields of the touch panel 10. That is, the worse the linearity is, the worse the precision of perceptions of positions is when a human finger contacts. But, the process of manufacturing of the discrete conductivity segments 101 is too complicated. So, if the process design can be simplified, touch liquid crystal displayers can be cost down, which will become advantageous to seek for compact sizes in touch liquid crystal displayers.

### SUMMARY OF THE INVENTION

A touch panel comprises a transparent conductive layer, a closed-loop electrode member circled around the transparent conductive layer, and a signal-transferring layer separated from the transparent conductive layer. The signal-transferring layer includes a transmission trace and a pad. The respective pads are located at four comers of the display device. Each transmission trace can conduct an electric current when an object contacts the transparent conductive layer. The signal-transferring layers and the electrode members are made of an identical conductivity material. The transparent conductive layer is indium tin oxide (ITO) film. And the signal-transferring layers and the electrode members are simultaneously formed by an identical manufacturing process. In addition, the electrode member is made of an electric-conductivity material with low resistivity.

In one aspect of the present invention, the touch panel is a surface capacitive touch panel or liquid crystal display panel for showing an image.

In another aspect of the present invention, the touch panel plug-in, built-in, or the combination thereof for use in a display device.

### BRIEF DESCRIPTION OF THE DRAWINGS

The present invention may best be understood through the following description with reference to the accompanying drawings, in which:

FIG. 1 shows a structure diagram of a conventional capacitive touch panel.

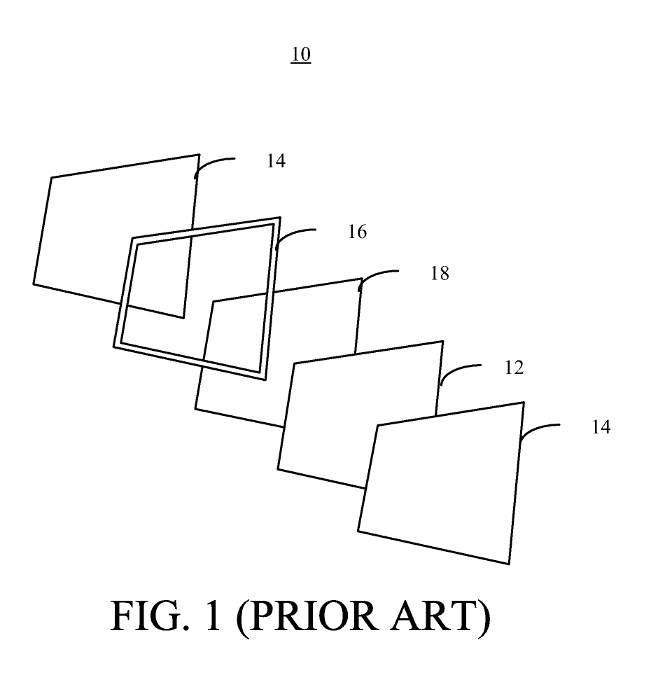

FIG. 2 illustrating a distribution diagram of an electrode layer of the conventional capacitive touch panel.

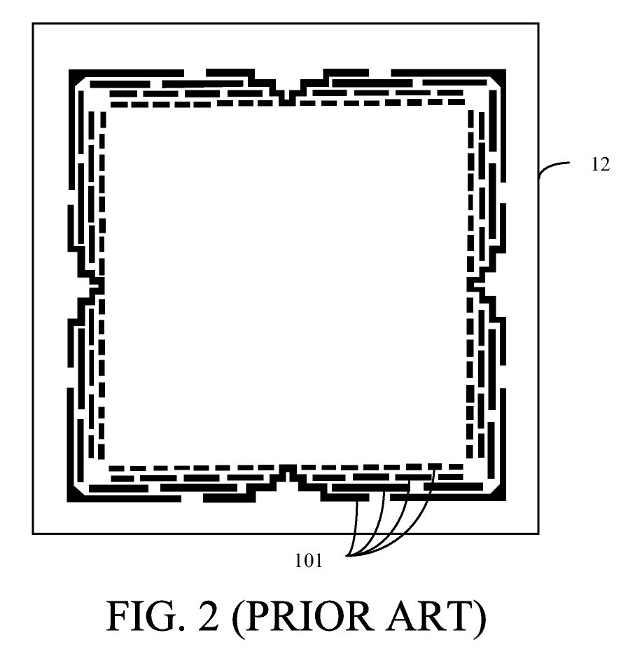

FIG. 3 shows a view of a touch display device according to a preferred embodiment of the present invention.

FIG. 4 illustrates a cross-sectional view of the touch display device in FIG. 3.

FIG. 5 is a top view of the touch panel in FIG. 4.

### DETAILED DESCRIPTION OF THE PREFERRED EMBODIMENT

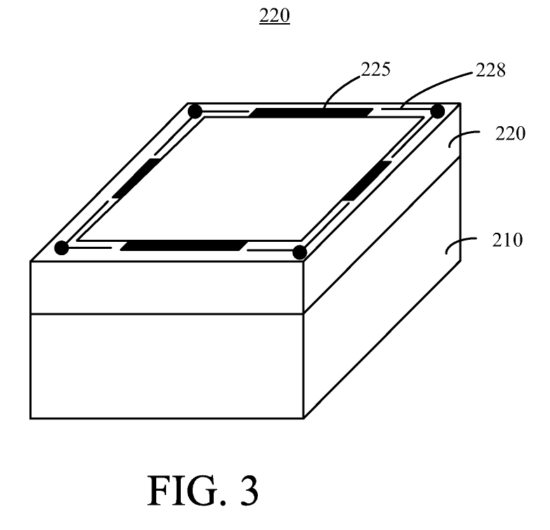

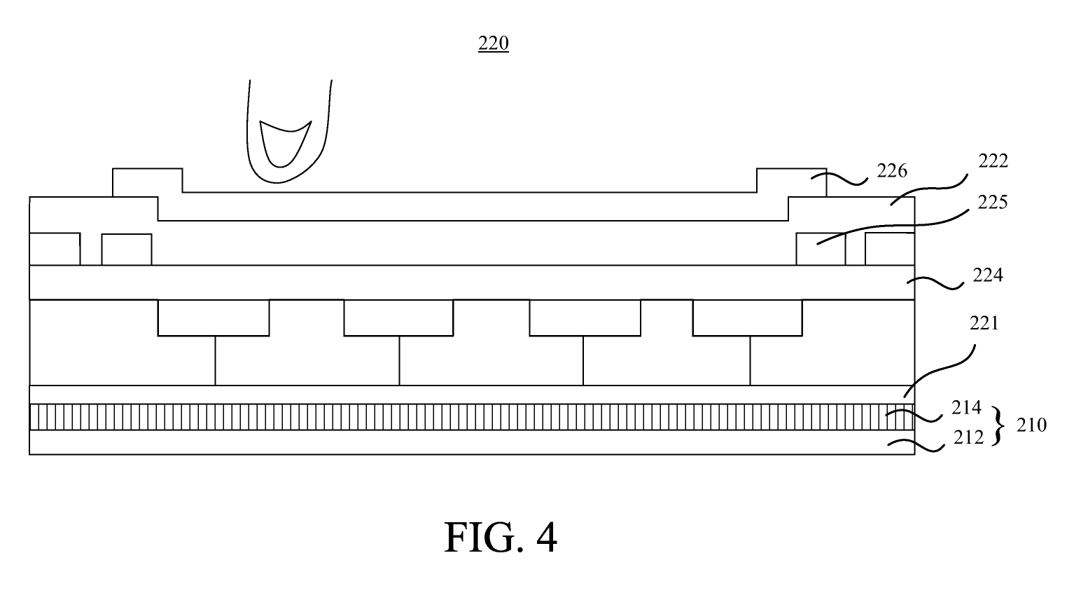

Referring to FIG. 3 and FIG. 4, FIG. 3 shows a view of a touch display device 200 according to a preferred embodiment of the present invention, and FIG. 4 illustrates a cross-sectional view of the touch display device 200 in FIG. 3. The touch display device 200 comprises a surface capacitive touch panel 220, which comprises transparent conductive layers 222 and electrode members 225. The touch panel 220 can be either plug-in, built-in, or the combination thereof for use in a display device. In this embodiment, the touch display device 200 is a display device utilizing the touch liquid crystal panel 210 which can show images. But practically, any display device using the present inventive touch panels 220 belongs to the scope of the present invention, not just limited in the liquid crystal panel device. The touch liquid crystal panel 210 comprises a pixel glass 212 and a liquid crystal layer 214. Depended upon voltage differences imposed on the liquid crystal layer 214, an alignment of the liquid crystal molecules within the liquid crystal layer 214 is changed to exhibit images of diverse gray scales. In order to fit in with the operation of the liquid crystal panel 210, the touch panel 220 further comprises a polarizer 226, a color filter 224, and transparent conductive layers 221, 222. The color filter 224 is used to filter out light of diverse spectra. The polarizer 226 is utilized to deflect the light filtered out by the color filter 224. The transparent conductive layers 221, 222 can be indium tin oxide (ITO) films.

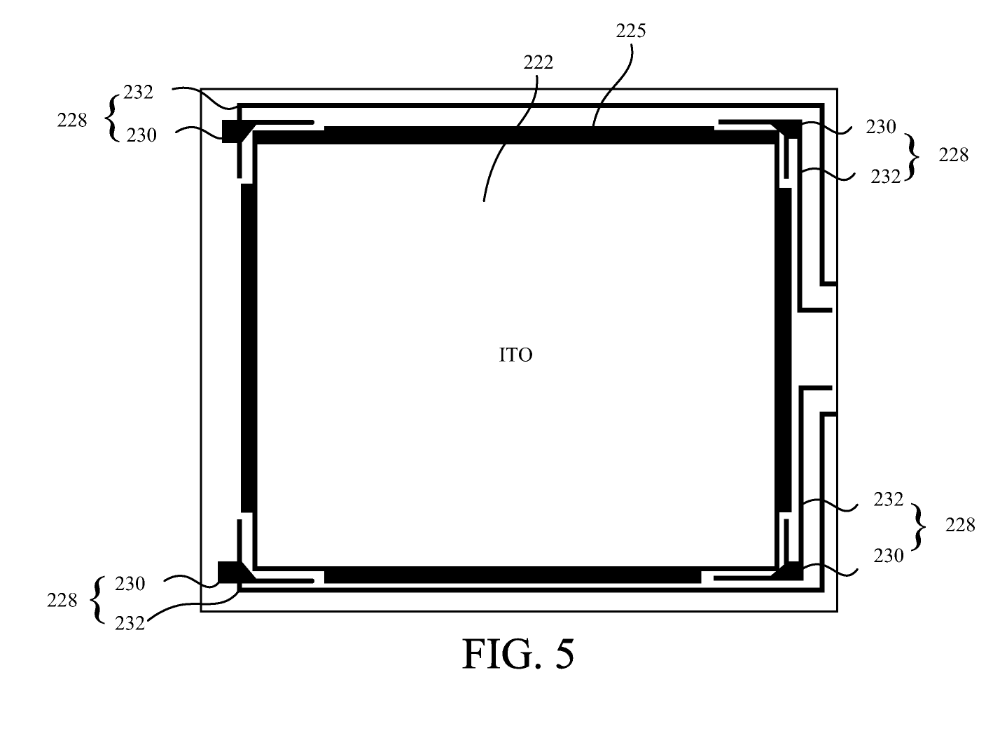

Referring to FIG. 5, FIG. 5 is the top view of the touch panel 220 in FIG. 4. In order to maintain the same electric field, the electrode member 225 is set up on the color filter 224 and surrounding the transparent conductive layer 222. The electrode members 225 circled the transparent conductive layer 222 forms a closed-loop construction. In addition, at least four discrete signal-transferring layers 228 are set up on the color filter 224 and surrounding the transparent conductive layer 222. Each signal-transferring layer 228 comprises a transmission trace 232 and a pad 230. The signal-transferring layers 228 and the electrode members 225 are separated. Each transmission pad 230 is set up independently on corners of the touch display device 200 and the transparent conductive layer 222. When a human's finger touches the touch panel on one position, an electric capacity will thus be formed between the transparent conductive layer 222 and the human's finger, and the electric field in the display area of the touch panel will thus be changed. When a user touches the touch zone above the transparent conductive layer 222 with a finger or other items, the transmission pad 230 of the electrode member 225 surrounding the transparent conductive layer 222 will produce different quantities of induced currents due to the different distances of the touch points, and transmit the induced currents to the processing units (not shown in the figures) of the touch display device 200 via the transmission traces 232. Then the processing units will determine the position coordinates of the touch points according to the quantities of the induced currents transmitted by each transmission trace 232.

In the process of manufacturing, the signal-transferring layers 228 and the electrode member 225 are made of an identical electric-conductivity material with low resistivity, such as silver, copper, etc. That is, the signal-transferring layers 228 and the electrode member 225 are manufactured in the same process.

In contrast to prior art, the present invention provides the electrode member 225 on the touch panel the display device 200 is a single enclosed construction and surrounds the top of the transparent conductive layer 222. And signal-transferring layers 228 are separately set up surrounding the transparent conductive layer 222. Besides, the signal-transferring layers 228 and the electrode members 225 are manufactured in the same process and made of the same electric-conductivity material. In this way, not only can the conventional processes be simplified, but the present process can apply to the equipments of the present LCD panels.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A touch panel comprising:
a transparent conductive layer;
a closed-loop electrode member circled around the transparent conductive layer; and
a signal-transferring layer separated from the transparent conductive layer, comprising a transmission trace and a pad,
wherein the signal-transferring layers and the electrode members are made of an identical conductivity material.

2. The touch panel of claim 1 being a surface capacitive touch panel.

3. The touch panel of claim 1 wherein the signal-transferring layers and the electrode members are simultaneously formed by an identical manufacturing process.

4. The touch panel of claim 1 wherein the electrode member is made of an electric-conductivity material with low resistivity.

5. The touch panel of claim 1 being plug-in, built-in, or the combination thereof for use in a display device.

6. The touch panel of claim 1 wherein the transparent conductive layer is indium tin oxide (ITO) film.
